(19) United States
(12) Patent Application Publication
(10) Pub. No.: US 2025/0300523 A1
(43) Pub. Date: Sep. 25, 2025

(54) ELECTRIC LIQUID PUMP

(71) Applicant: TOYODA GOSEI CO., LTD., Kiyosu-shi (JP)

(72) Inventors: Mitsuhiro YOSHIMURA, Aichi-ken (JP); Shinya SAKAI, Aichi-ken (JP); Satoshi SUZUKI, Aichi-ken (JP); Naoki NISHIMOTO, Aichi-ken (JP); Kentaro KURODA, Aichi-ken (JP)

(21) Appl. No.: 19/077,118

(22) Filed: Mar. 12, 2025

(30) Foreign Application Priority Data
Mar. 20, 2024 (JP) 2024-044304

(51) Int. Cl. H02K 7/04; F04C 2/08; F04C 15/00

(52) U.S. Cl. CPC H02K 7/04; F04C 2/082; F04C 15/008; F04C 2210/20; F04C 2240/40; F04C 2240/80

(57) ABSTRACT

An electric liquid pump has a motor, a liquid pump including an inner rotor having an external tooth and integrated with an axial end of a shaft of the motor and an outer rotor having an internal tooth meshing with the external tooth and forming a gap into which a liquid is suctioned and from which the liquid is discharged, a motor case having a box shape and including therein a first accommodation chamber, a second accommodation chamber, and a partition wall allowing the first and second accommodation chambers to communicate with each other, and a body including a centering body portion, a general body portion, and a bearing portion formed to penetrate the centering body portion and the general body portion. The entire body is made of a thermosetting resin.

### CROSS-REFERENCE TO RELATED APPLICATIONS

This application is based on and claims priority under 35 USC 119 from Japanese Patent Application No. 2024-044304 filed on Mar. 20, 2024, the entire content of which is incorporated herein by reference.

### TECHNICAL FIELD

The present disclosure relates to an electric liquid pump that transports a liquid such as oil.

### BACKGROUND ART

As an electric liquid pump that transports a liquid such as oil, there has been an electric liquid pump in which an inner rotor and an outer rotor that achieve a pump function are accommodated in a case (see, for example, JP2017-066975A).

In the electric liquid pump described in JP2017-066975A, a trochoid 4, which is an integrated product of an inner rotor 3 and an outer rotor 2, is accommodated by a casing 5 and a cover 6.

When a drive shaft 10 connected to a drive source rotates, the inner rotor 3 integrated with the drive shaft 10 rotates. As the inner rotor 3 rotates, the outer rotor 2 meshing with the inner rotor 3 rotates. Accordingly, the pump function of suctioning and discharging the liquid is achieved.

In the electric liquid pump, a portion accommodating the inner rotor and the outer rotor and a portion supporting a drive shaft are required to have high dimensional accuracy. Therefore, in a general electric liquid pump in the related art, these portions are made of metal, and a step of further cutting is required after molding. Accordingly, it is difficult to reduce a weight of the electric liquid pump in the related art, and a manufacturing cost is high.

An electric liquid pump having a large mass is not suitable as, for example, an in-vehicle electric liquid pump mounted on a vehicle.

For example, in the technique described in JP2017-066975A described above, the cover 6 which is a portion supporting the drive shaft 10 is also made of metal, and a bearing that supports the drive shaft 10 is press-fitted into the cover 6. In a general electric liquid pump, a metal bearing is used as the bearing.

It is difficult to reduce a weight of such a cover 6, and as a result, it is difficult to say that the electric liquid pump including the cover 6 is sufficiently lightweight.

Further, the electric liquid pump described in JP2017-066975A requires a metal plate 8. Accordingly, it can be said that it is difficult to reduce the weight of the electric liquid pump.

Therefore, even with the technique described in the above-mentioned JP2017-066975A, it is difficult to say that the weight of the electric liquid pump can be sufficiently reduced and a manufacturing cost thereof can be sufficiently reduced.

### SUMMARY OF INVENTION

An object of the present disclosure is to provide a technique capable of reducing a weight of an electric liquid pump and reducing a manufacturing cost thereof.

An aspect of the technique of the present disclosure relates to an electric liquid pump having:
an electric motor including a motor rotor that has a shaft and a magnet portion integrated with one axial end of the shaft, and a stator that is disposed radially outside or inside the magnet portion and rotates the motor rotor;
a liquid pump including an inner rotor that has an external tooth and is integrated with an other axial end of the shaft, and an outer rotor that has an internal tooth meshing with the external tooth and forms, together with the inner rotor, a gap volume portion into which a liquid is suctioned from a suction passage and from which the liquid is discharged toward a discharge passage;
a motor case having a box shape and including therein a first accommodation chamber that accommodates the stator and one axial part of the motor rotor including the magnet portion, a second accommodation chamber that communicates with the first accommodation chamber and accommodates an other axial part of the motor rotor, and a partition wall that has a hole-shaped communication portion allowing the first accommodation chamber and the second accommodation chamber to communicate with each other and is provided between the first accommodation chamber and the second accommodation chamber, in which the liquid circulates through the first accommodation chamber, the second accommodation chamber, and the hole-shaped communication portion; and
a body including a centering body portion inserted into the hole-shaped communication portion to be centered, a general body portion being continuous with the centering body portion and accommodated in the second accommodation chamber, and a bearing portion formed to penetrate the centering body portion and the general body portion and supporting an axial one portion of the shaft at a position between the magnet portion and the inner rotor,
in which the entire body is made of a thermosetting resin.

According to the technique of the present disclosure, it is possible to reduce a weight of the electric liquid pump and reduce a manufacturing cost thereof.

### BRIEF DESCRIPTION OF DRAWINGS

Exemplary embodiment(s) of the present invention will be described in detail based on the following figures, wherein:

FIG. 1 is a diagram schematically illustrating an appearance of an electric liquid pump according to a first example;

FIG. 2 is a diagram schematically illustrating a state in which the electric liquid pump according to the first example is cut at an X-X position in FIG. 1; and

FIG. 3 is a diagram schematically illustrating a state in which the electric liquid pump according to the first example is cut at a Y-Y position in FIG. 1.

### DESCRIPTION OF EMBODIMENTS

Hereinafter, an electric liquid pump of the present disclosure will be described with reference to specific examples.

The electric liquid pump according to the present disclosure includes a motor rotor, a stator, an inner rotor, an outer rotor, a motor case, and a body. The inner rotor and the outer rotor among these members form a liquid pump, and the motor rotor and the stator form an electric motor that drives the liquid pump.

The motor case and the body function as a housing that accommodates therein at least a part of the liquid pump and the electric motor.

Among these members, the body also functions as a support mechanism that supports the liquid pump and the electric motor. That is, the body of the electric liquid pump according to the present disclosure has a function of the cover 6 and a function of the casing 5 described in the above JP2017-066975A.

In other words, the electric liquid pump according to the present disclosure requires only the body instead of the two members, that is, the cover and the casing, which have been required in the related art. Therefore, according to the electric liquid pump of the present disclosure, the number of components is reduced. Accordingly, the number of steps of manufacturing the electric liquid pump can be reduced, and thus a manufacturing cost of the electric liquid pump can be reduced.

In the electric liquid pump according to the present disclosure, the inner rotor, the outer rotor, and the body supporting a shaft of the motor rotor are made of a thermosetting resin, and a liquid circulates inside the motor case.

Therefore, in the electric liquid pump according to the present disclosure, for example, there is no need for a structure such as a metal bearing as a bearing portion that supports the shaft of the motor rotor.

That is, the electric liquid pump in the related art requires a bearing portion including the metal bearing as the bearing that supports the shaft of the motor rotor.

The bearing is a mechanism that smoothly rotates the shaft, and for example, a rolling bearing type bearing, which is a general bearing, has a three-layer structure of an inner ring, a ball, and an outer ring, and is a member having a relatively large mass. Therefore, it is difficult to reduce a weight of the electric liquid pump including the bearing in the bearing portion.

In the electric liquid pump according to the present disclosure, the shaft of the motor rotor is supported by the body made of the thermosetting resin. Further, the liquid circulating inside the motor case is also supplied between the body and the shaft, and can function as a lubricant.

That is, in the electric liquid pump according to the present disclosure, by circulating the liquid inside the motor case, it is possible to rotate the shaft smoothly, even though a part of the body made of the thermosetting resin, which is lighter than metal, is used instead of the bearing.

Accordingly, the electric liquid pump according to the present disclosure can achieve weight reduction.

In the electric liquid pump according to the present disclosure, the body itself made of the thermosetting resin is lightweight, whereby the weight of the electric liquid pump as a whole is also reduced. Further, it can be said that such an electric liquid pump according to the present disclosure is greatly reduced in weight as compared with an electric liquid pump including a metal cover, such as the electric liquid pump described in JP2017-066975A.

Further, since the body made of the thermosetting resin is used and a metal body or a metal cover is eliminated, a cutting process for manufacturing the body or the cover becomes unnecessary. Accordingly, according to the electric liquid pump of the present disclosure, the manufacturing cost can be further reduced.

As a result of the cooperation described above, the electric liquid pump according to the present disclosure can reduce the weight of the electric liquid pump and the manufacturing cost thereof.

Hereinafter, the electric liquid pump according to the present disclosure will be described for each component.

In the present specification, when a radial direction and an axial direction are simply mentioned, the radial direction and the axial direction mean a radial direction and an axial direction of the shaft of the electric motor.

Unless otherwise specified, a numerical range “x to y” described in the present specification includes a lower limit value x and an upper limit value y. The upper limit value, the lower limit value, and numerical values listed in the examples may be freely combined to form a numerical value range. Further, numerical values freely selected from the numerical value range can be set as an upper limit numerical value and a lower limit numerical value.

The electric liquid pump according to the present disclosure is a pump that transports a liquid such as oil and various coolants, and can be embodied, for example, as a pump mounted on a vehicle for supplying oil to a drive system such as a transmission. The electric liquid pump according to the present disclosure may be a small pump mounted on a vehicle or the like, or may be a stationary pump installed in various facilities or the like.

The electric liquid pump according to the present disclosure includes the electric motor, the liquid pump, the motor case, and the body.

Among these members, the electric motor includes the motor rotor and the stator. The electric motor in the electric liquid pump according to the present disclosure may be an inner rotor type motor in which a stator is disposed radially outside of a motor rotor, or an outer rotor type motor in which a stator is disposed radially inside of a motor rotor.

The shaft is a long member that constitutes a rotating shaft of the motor rotor, and it is preferable that a material used for the shaft is one that is difficult to deform.

The shaft may be made of a magnetic material or a non-magnetic material, but is preferably made of a magnetic material in order to function as a back yoke for a magnet portion.

The shaft may have a constant shape in radial cross section, or may have a T-shaped cross section with a sleeve having a larger diameter than other portions at one axial end, that is, a portion integrated with the magnet portion. When the shaft includes the sleeve, the magnet portion is integrated with the sleeve. Therefore, when the sleeve is provided on the shaft, the above function as the back yoke can be effectively exerted, and there is also an advantage that the magnet portion can be made smaller by an amount of the sleeve.

The magnet portion may be a permanent magnet that can generate a magnetic field, or any one. The magnet portion may be, for example, a bonded magnet.

The bonded magnet is a magnet made by bonding magnetic powder with a binder. The magnetic powder may be any known material such as SmFeN-based magnetic powder, ferrite-based magnetic powder, or neodymium-based magnetic powder. As the binder, known materials such as a resin and an elastomer may be used.

By using the bonded magnet as the magnet portion, it is possible to reduce the mass of the magnet portion by an amount of the binder.

By using the bonded magnet as the magnet portion, a weight of the entire motor rotor is reduced. Accordingly, another advantage is that rotational torque of a motor rotor made of metal can be reduced, and a body made of a thermosetting resin, which does not include a bearing, allows the shaft of the motor rotor to rotate more smoothly.

Further, when the bonded magnet is used for the magnet portion, the rotational torque of the motor rotor is reduced, so that a small stator can be used. Accordingly, the electric liquid pump according to the present disclosure can also achieve reduction in weight.

A method for integrating the magnet portion and the shaft is not particularly limited, and for example, the magnet portion and the shaft may be integrated at the time of molding by insert molding or the like, or a magnet portion molded in advance may be fixed to the shaft using a method such as adhesion.

The stator is a portion that generates a force for rotating a rotor, and a stator having a known structure, such as a stator in which a coil is wound around a core, may be used.

The liquid pump includes the inner rotor and the outer rotor.

The inner rotor includes external teeth and is integrated with the other axial end of the shaft. Therefore, the inner rotor rotates together with the shaft.

The outer rotor includes internal teeth that mesh with the external teeth of the inner rotor. In other words, the inner rotor is disposed inside the outer rotor, and the outer rotor rotates following rotation of the inner rotor.

A gap volume portion is formed between the inner rotor and the outer rotor. As the inner rotor and the outer rotor rotate, the liquid is suctioned from a suction passage outside the electric liquid pump toward the gap volume portion, and the liquid is discharged from the gap volume portion toward a discharge passage outside the electric liquid pump.

Shapes of the inner rotor and the outer rotor for forming the gap volume portion may be general shapes used for a liquid pump.

Specifically, in a general oil pump, the inner rotor and the outer rotor mesh with each other in an eccentric manner. The inner rotor has a plurality of external teeth. The outer rotor is located radially outside the inner rotor and includes the internal teeth that mesh with the external teeth of the inner rotor. The number of internal teeth of the outer rotor is different from the number of external teeth of the inner rotor.

When the shaft rotates, the inner rotor integrated with the shaft rotates integrally with the shaft. Thus, the outer rotor, which meshes with the inner rotor, rotates eccentrically relative to the inner rotor. When such rotation occurs, volumes of a plurality of gap volume portions formed between the inner rotor and the outer rotor change sequentially by repeatedly decreasing and increasing. Accordingly, oil is suctioned up by a negative pressure from the suction passage outside the electric liquid pump to the gap volume portion, and the oil is pumped by compression from the gap volume portion to the discharge passage outside the electric liquid pump.

The inner rotor and the outer rotor may have any general shape that can perform the above-mentioned pump function.

The motor case is a box-shaped member that accommodates the motor rotor including the magnet portion, the stator, and the body.

The motor case has a first accommodation chamber and a second accommodation chamber therein, and has a partition wall between the first accommodation chamber and the second accommodation chamber. The partition wall is provided with a hole-shaped communication portion that allows the first accommodation chamber and the second accommodation chamber to communicate with each other. The partition wall may have a passage that allows the first accommodation chamber and the second accommodation chamber to communicate with each other in addition to the hole-shaped communication portion.

The magnet portion, the stator, and the one axial end of the shaft integrated with the magnet portion are accommodated in the first accommodation chamber. In other words, the stator and one axial part of the motor rotor including the magnet portion are accommodated in the first accommodation chamber. The first accommodation chamber can also be regarded as a motor chamber that accommodates a portion of the electric liquid pump according to the present disclosure which functions as the electric motor.

The second accommodation chamber accommodates the other axial part of the shaft, that is, the other axial part of the motor rotor. Further, the second accommodation chamber accommodates a general body portion that is a part of the body. For the convenience of accommodating the body, it is preferable that an end of the second accommodation chamber opposite the first accommodation chamber is opened. Hereinafter, the opening is referred to as a case opening as necessary.

As described above, the first accommodation chamber and the second accommodation chamber are partitioned by the partition wall and communicate with each other by the hole-shaped communication portion. Therefore, one portion of the motor rotor between a portion accommodated in the first accommodation chamber and the other axial portion accommodated in the second accommodation chamber may be said to be accommodated in the hole-shaped communication portion. Specifically, this portion is a portion of the shaft between the one axial end and the other axial end.

The body includes a centering body portion and a general body portion. The centering body portion is a portion that is inserted into the hole-shaped communication portion and performs centering of the body with respect to the motor case, and an outer shape of the centering body portion substantially matches a hole shape of the hole-shaped communication portion.

The body of the electric liquid pump according to the present disclosure is made of a thermosetting resin. The thermosetting resin as a material for the body will be described in detail later.

The general body portion is a portion continuous with the centering body portion and is accommodated in the second accommodation chamber of the motor case.

A bearing portion is formed to penetrate the centering body portion and the general body portion. The bearing portion is a simple through hole including no bearing or the like. However, an oil groove that improves lubricity between the shaft and the bearing portion may be provided in the bearing portion.

The bearing portion accommodates a portion of the shaft of the motor rotor between the one end and the other end, that is, a portion that is not integrated with the magnet portion or the inner rotor.

The inner rotor is integrated with the other axial end side of the shaft of the motor rotor.

The inner rotor may be disposed outside the body, but is preferably disposed inside the body in order to reduce the size and the weight of the electric liquid pump according to the present disclosure.

That is, it is preferable that a rotor accommodation chamber that accommodates the inner rotor and the outer rotor is provided at an end of the general body portion opposite to the centering body portion. The rotor accommodation chamber communicates with the bearing portion due to a positional relationship among the shaft, the inner rotor, and the outer rotor.

When the general body portion has the rotor accommodation chamber that accommodates the inner rotor and the outer rotor, it is preferable that the inner rotor and the outer rotor are also accommodated in the motor case together with the general body portion.

The general body portion and the motor case are integrated together in a state in which the centering body portion is inserted into the hole-shaped communication portion to be centered, but may be integrated together in other portions. For example, when the second accommodation chamber has a case opening, the general body portion may close the case opening, and the general body portion and the motor case may be centered at a peripheral edge portion of the case opening.

Further, a centering portion between the general body portion and the motor case may also be used as an attachment portion that attaches the electric liquid pump according to the present disclosure to a counterpart member such as an oil pan for supplying a liquid to the liquid pump. In this case, a structure for integrating the body and the motor case in the electric liquid pump according to the present disclosure and a structure for attaching the electric liquid pump according to the present disclosure to the counterpart member can be formed into simple and non-bulky shapes. This contributes to further reduction in size and weight of the electric liquid pump according to the present disclosure.

In the electric liquid pump according to the present disclosure, materials for the inner rotor and the outer rotor are not particularly limited, and may be made of metal such as aluminum or may be made of a resin. At least one of the inner rotor and the outer rotor is preferably made of a resin, and among the resins, it is preferable that the rotor is made of a thermosetting resin. Hereinafter, the one of the inner rotor and the outer rotor, which is made of the resin, may be referred to as a resin rotor as necessary.

By using the thermosetting resin as the material for the resin rotor, the weight reduction can be achieved while maintaining heat resistance of the resin rotor. Only one of the inner rotor and the outer rotor may be a resin rotor, but both the inner rotor and the outer rotor are preferably resin rotors. Further, it is particularly preferable that both the inner rotor and the outer rotor are resin rotors and made of the thermosetting resin.

When the inner rotor and the outer rotor are the resin rotors, a material for the inner rotor and a material for the outer rotor may be the same or different. Further, the materials for the inner rotor and the outer rotor may be the same as the material for the body.

There are no particular limitations on the thermosetting resin used as the material for the body and, if necessary, the material for the inner rotor and/or the outer rotor, and the thermosetting resin may be selected appropriately taking into consideration resistance to deterioration and infiltration by the liquid suctioned in and discharged by the electric liquid pump according to the present disclosure, and the seizure resistance and sliding properties of the bearing portion. For example, when the electric liquid pump according to the present disclosure is an oil pump for a vehicle, a phenol resin is preferably used as the thermosetting resin.

In the present disclosure, the term “made of a thermosetting resin” includes not only those made of only thermosetting resin, but also those made of a mixed material of a thermosetting resin and various compounding agents.

The compounding agent referred to here means a material other than the thermosetting resin, and examples thereof include reinforcing fibers such as a glass fiber and a carbon fiber, various inorganic fillers typified by glass beads and mineral powders such as talc and mica, defoamers, and various additives such as pigments.

An amount of the compounding agent with respect to the thermosetting resin is not particularly limited, but is preferably, for example, 90% by mass or less, 70% by mass or less, or 50% by mass or less with respect to 100% by mass of the thermosetting resin.

In the electric liquid pump according to the present disclosure, a material for the motor case is not particularly limited.

Hereinafter, the electric liquid pump according to the present disclosure will be described with reference to specific examples.

### First Example

An electric liquid pump according to a first example is mounted on a vehicle to suction up oil from an oil pan and supply the oil to a drive system such as a transmission, and a liquid in the electric liquid pump is the oil.

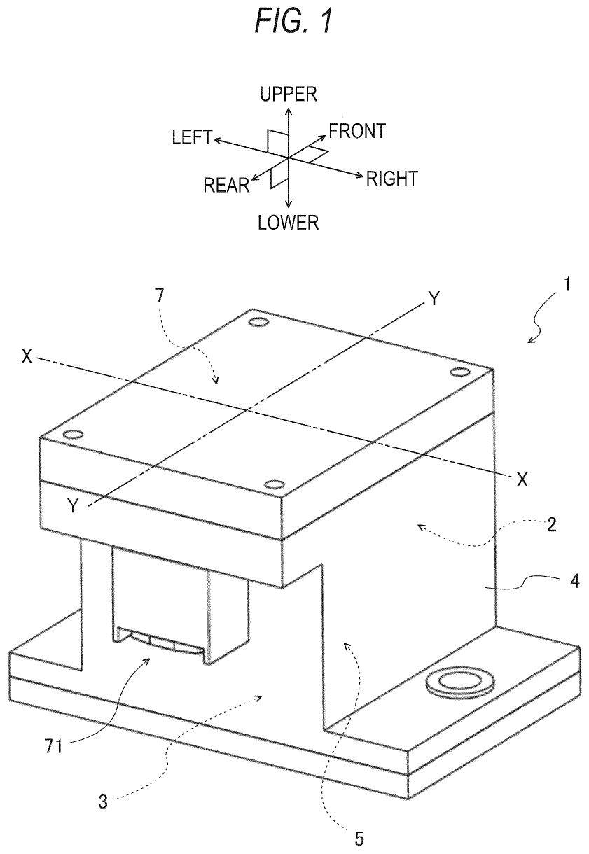

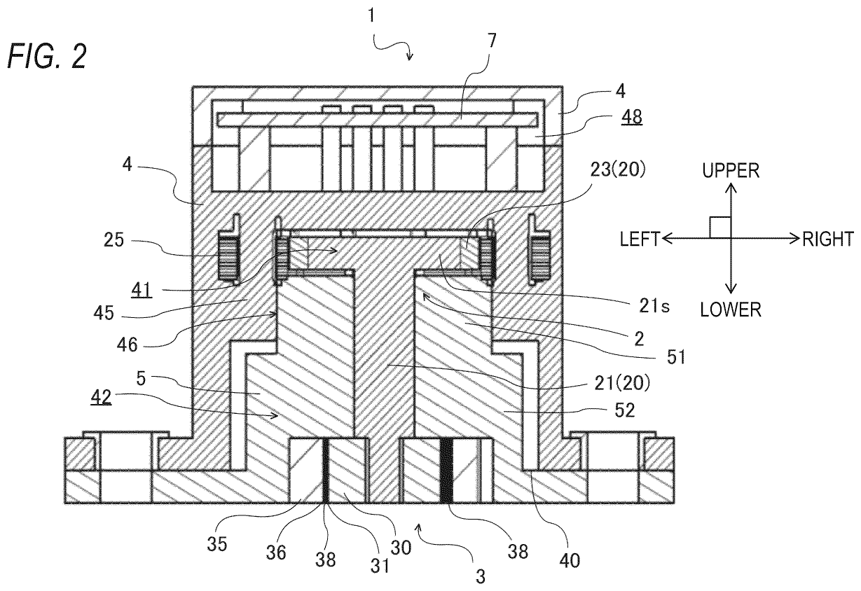

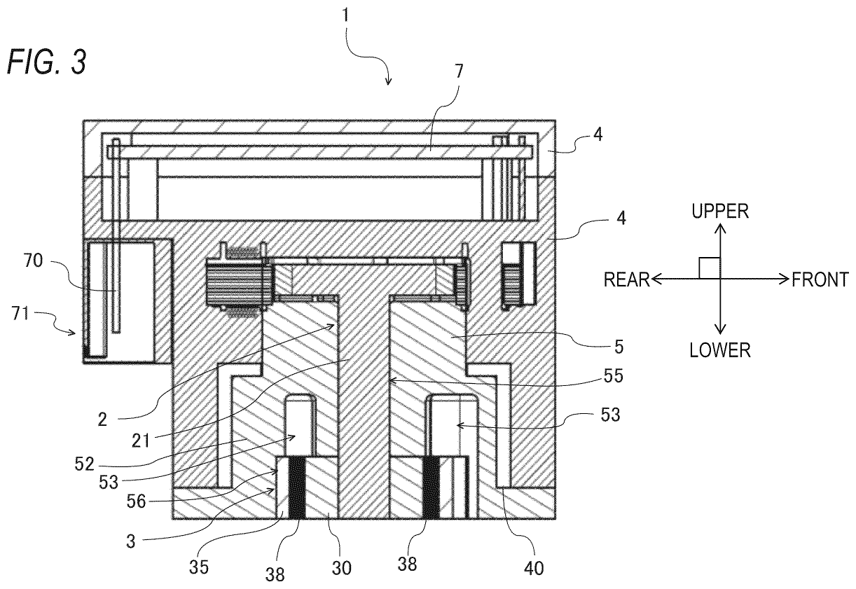

FIG. 1 shows a diagram schematically illustrating an appearance of the electric liquid pump according to the first example. FIG. 2 shows a diagram schematically illustrating a state in which the electric liquid pump according to the first example is cut at an X-X position in FIG. 1. FIG. 3 shows a diagram schematically illustrating a state in which the electric liquid pump according to the first example is cut at a Y-Y position in FIG. 1.

Hereinafter, upper, lower, left, right, front, and rear in the first example mean upper, lower, left, right, front, and rear shown in the drawings. An upper-lower direction coincides with the axial direction of the motor rotor.

As shown in FIGS. 1 to 3, an electric liquid pump 1 according to the first example includes an electric motor 2, a liquid pump 3, a motor case 4, and a body 5.

As shown in FIGS. 2 and 3, the electric motor 2 includes a motor rotor 20 and a stator 25

The motor rotor 20 includes a shaft 21 and a magnet portion 23, and an axial cross section thereof is substantially T-shaped.

Among these members, the shaft 21 is an elongated member made of magnetic metal, and includes a sleeve 21s having a larger diameter than other portions at one axial end thereof.

The magnet portion 23 is a bonded magnet, is integrated with an outer peripheral surface of the sleeve 21s, and extends further radially outside the sleeve 21s.

The stator 25 is disposed radially outside the magnet portion 23. A control board 7 is connected to the stator 25 via a lead wire (not shown).

As shown in FIG. 3, a lead wire 70 is further connected to the control board 7 and directed toward an outside of the electric liquid pump 1. An end of the lead wire 70 forms a connection terminal portion 71 that supplies power to the electric motor 2 according to the first example and inputs and outputs signals.

The liquid pump 3 includes an inner rotor 30 and an outer rotor 35. The inner rotor 30 and the outer rotor 35 are made of a phenol resin.

The inner rotor 30 includes external teeth 31 and is integrated with the other axial end of the shaft 21, that is, a lower end in FIGS. 2 and 3. Since the inner rotor 30 is integrated with the shaft 21 of the motor rotor 20, when the motor rotor 20 rotates due to action of the stator 25 and the magnet portion 23, the inner rotor 30 rotates together with the motor rotor 20.

The outer rotor 35 includes internal teeth 36 that mesh with the external teeth 31 of the inner rotor 30, and is disposed outside the inner rotor 30 so as to surround the inner rotor 30.

A gap volume portion 38 that achieves a pump function is formed between the inner rotor 30 and the outer rotor 35.

The motor case 4 is made of a polyphenylene sulfide resin containing reinforcing fibers, is box-shaped, and has a case opening 40 that opens downward. A first accommodation chamber 41 and a second accommodation chamber 42 are provided inside the motor case 4. Inside the motor case 4, the first accommodation chamber 41 is disposed on an upper side, the second accommodation chamber 42 is disposed on a lower side, and a partition wall 45 is provided between the first accommodation chamber 41 and the second accommodation chamber 42.

The partition wall 45 is provided with a hole-shaped communication portion 46 having a through-hole shape penetrating the partition wall 45 in the upper-lower direction, which is a thickness direction thereof. In the electric liquid pump 1 according to the first example, a hole diameter of the hole-shaped communication portion 46 is substantially the same as an inner diameter of the first accommodation chamber 41.

An upper portion of the motor rotor 20 including the magnet portion 23 and the stator 25 are accommodated in the first accommodation chamber 41 of the motor case 4. The stator 25 is disposed radially outside the magnet portion 23 so as to surround the magnet portion 23.

An inner portion of the stator 25, that is, a portion of the stator 25 on a motor rotor 20 side is exposed to the first accommodation chamber 41. An outer portion of the stator 25 is located outside the first accommodation chamber 41 and enters a wall portion of the motor case 4.

In the electric liquid pump 1 according to the first example, a portion of the motor case 4 above the first accommodation chamber 41 is divided into upper and lower portions, and a board chamber 48 is formed between the upper and lower portions.

The board chamber 48 is liquid-tightly isolated from the first accommodation chamber 41 and the second accommodation chamber 42, and the control board 7 for the stator 25 is disposed in the board chamber 48. The control board 7 is electrically connected to the stator 25 by a lead wire extending from the first accommodation chamber 41 to the board chamber 48. Therefore, a communication path (not shown) through which the lead wire passes is formed in a portion between the first accommodation chamber 41 and the board chamber 48 in the motor case 4. However, a gap between the communication path and the lead wire is liquid-tightly sealed at a boundary portion between the first accommodation chamber 41 and the board chamber 48. Therefore, the board chamber 48 in the electric liquid pump 1 according to the first example is liquid-tightly isolated from the first accommodation chamber 41 and the second accommodation chamber 42.

The hole-shaped communication portion 46 and the second accommodation chamber 42 are continuous, and a portion of the motor rotor 20 other than a portion accommodated in the first accommodation chamber 41 is accommodated in the hole-shaped communication portion 46 or the second accommodation chamber 42.

The body 5 is made of a phenol resin.

A centering body portion 51, which is a part of the body 5, is inserted into the hole-shaped communication portion 46. An outer shape of the centering body portion 51 is substantially the same as a hole shape of the hole-shaped communication portion 46, whereby the centering body portion 51 is fitted to the hole-shaped communication portion 46 and centered, that is, positioned with respect to the partition wall 45 and the motor case 4.

An upper portion of a general body portion 52 continuous with the centering body portion 51 is accommodated in the second accommodation chamber 42 continuous with the hole-shaped communication portion 46. An outer shape of the upper portion of the general body portion 52 is slightly smaller than an inner shape of the second accommodation chamber 42, and a small space is formed in the second accommodation chamber 42 at a portion outside the general body portion 52. The space functions as an oil circulation space.

Further, as shown in FIG. 3, a plurality of recesses 53 are formed inside the general body portion 52. An inside of each of the recesses 53 communicates with the gap volume portion 38 formed between the inner rotor 30 and the outer rotor 35.

A bearing portion 55 is formed to penetrate the centering body portion 51 and the general body portion 52. The bearing portion 55 is a through hole extending in the upper-lower direction. A central portion of the shaft 21 of the motor rotor 20 is supported by the bearing portion 55. More specifically, an axial central portion of the shaft 21 of the motor rotor 20 is inserted into the through-hole-shaped bearing portion 55 provided in the body 5, and as a result, the bearing portion 55 supports the entire shaft 21, the magnet portion 23 integrated with the one axial end of the shaft 21, and the inner rotor 30 integrated with the other axial end of the shaft 21.

The inner rotor 30 is integrated with the lower end of the shaft 21 of the motor rotor 20. The inner rotor 30 is accommodated together with the outer rotor 35 in a rotor accommodation chamber 56 provided at an end of the general body portion 52 opposite to the centering body portion 51.

The rotor accommodation chamber 56 is larger than the bearing portion 55, is located below the bearing portion 55, and accommodates with the bearing portion 55. A lower portion of the rotor accommodation chamber 56 is opened. Further, there are the recesses 53 on an upper side of the rotor accommodation chamber 56, and the inside of each of the recesses 53 communicates with the rotor accommodation chamber 56. As described above, since the inner rotor 30 and the outer rotor 35 are accommodated in the rotor accommodation chamber 56, it can be said that the inside of the recess 53 also communicates with the gap volume portion 38 formed between the inner rotor 30 and the outer rotor 35 via the rotor accommodation chamber 56.

A lower end of the general body portion 52 is larger than the second accommodation chamber 42, extends in the radial direction perpendicular to the upper-lower direction, and is exposed to a lower side of the motor case 4 through the case opening 40.

A lower end of the motor case 4, in other words, a peripheral edge portion of the case opening 40 also extends in the radial direction perpendicular to the upper-lower direction.

As shown in FIG. 2, through holes are formed in the lower end of the general body portion 52 and in the peripheral edge portion of the case opening 40 at positions facing each other. A fixture (not shown) is inserted into the through hole, and the lower end of the general body portion 52 is fixed to the peripheral edge portion of the case opening 40 by the fixture. The lower end of the general body portion 52 can be said to close the case opening 40.

In the electric liquid pump 1 according to the first example, the body 5, the inner rotor 30, and the outer rotor 35 are made of the phenol resin, which is a kind of the thermosetting resin. Therefore, the electric liquid pump 1 according to the first example is lightweight.

The electric liquid pump 1 according to the first example does not require a bearing that supports the shaft 21. Therefore, the electric liquid pump 1 according to the first example is small and lightweight.

Further, in the electric liquid pump according to the first example, the body 5 has a function of accommodating the liquid pump 3 and a function of supporting the liquid pump 3 and the electric motor 2. Since the body 5 has many functions as described above, the number of components in the electric liquid pump 1 according to the first example is reduced, and thus the number of steps of manufacturing the electric liquid pump 1 is reduced, and a manufacturing cost of the electric liquid pump 1 is reduced.

In the electric liquid pump 1 according to the first example, since the material for the body 5 is the thermosetting resin, metal cutting is not required at the time of manufacturing, thereby further reducing the manufacturing cost.

As a result of the cooperation described above, the electric liquid pump 1 according to the first example can achieve the reduction in weight and manufacturing cost.

Although the present disclosure has been described above, the present invention is not limited to the above-described examples and the like, the elements described in the examples and the like can be appropriately extracted and combined, and various modifications can be made without departing from the scope of the present invention.

In addition, the description of the present disclosure is not limited to the citation relationships of claims at the beginning of the application, and discloses a technical idea obtained by appropriately combining the matters described in each claim.

What is claimed is:

1. An electric liquid pump comprising:
an electric motor including a motor rotor that has a shaft and a magnet portion integrated with one axial end of the shaft, and a stator that is disposed radially outside or inside the magnet portion and rotates the motor rotor;
a liquid pump including an inner rotor that has an external tooth and is integrated with an other axial end of the shaft, and an outer rotor that has an internal tooth meshing with the external tooth and forms, together with the inner rotor, a gap volume portion into which a liquid is suctioned from a suction passage and from which the liquid is discharged toward a discharge passage;
a motor case having a box shape and including therein a first accommodation chamber that accommodates the stator and one axial part of the motor rotor including the magnet portion, a second accommodation chamber that communicates with the first accommodation chamber and accommodates an other axial part of the motor rotor, and a partition wall that has a hole-shaped communication portion allowing the first accommodation chamber and the second accommodation chamber to communicate with each other and is provided between the first accommodation chamber and the second accommodation chamber, in which the liquid circulates through the first accommodation chamber, the second accommodation chamber, and the hole-shaped communication portion; and
a body including a centering body portion inserted into the hole-shaped communication portion to be centered, a general body portion being continuous with the centering body portion and accommodated in the second accommodation chamber, and a bearing portion formed to penetrate the centering body portion and the general body portion and supporting an axial one portion of the shaft at a position between the magnet portion and the inner rotor,
wherein the entire body is made of a thermosetting resin.

2. The electric liquid pump according to claim 1,
wherein the thermosetting resin includes a phenol resin.

3. The electric liquid pump according to claim 2,
wherein the thermosetting resin contains a reinforcing fiber and/or an inorganic filler in an amount of 30% by mass or more and 90% by mass or less when a total amount of the thermosetting resin is 100% by mass.

4. The electric liquid pump according to claim 1,
herein the body is formed by injection molding or compression molding.
